(19) United States
(12) Patent Application Publication
(10) Pub. No.: US 2011/0090330 A1
(43) Pub. Date: Apr. 21, 2011

(54) VIDEO CAPTURE SYSTEM, IN PARTICULAR FOR FISHING

(76) Inventor: Nazario Luzi, Fermo AP (IT)

(21) Appl. No.: 13/000,017

(22) PCT Filed: Jun. 19, 2009
(86) PCT No.: PCT/IT2009/000272

§ 371 Date: Dec. 19, 2010

(30) Foreign Application Priority Data
Jun. 20, 2008 (IT) MC2008A000120

(51) Int. Cl. H04N 7/18

(52) U.S. Cl. 348/81; 348/E07.085

(57) ABSTRACT

A video capture system is disclosed, in particular for fishing, including a transmitter unit and a receiver unit connected by a cable transmission line. The transmitter unit has a telecamera and a transmit driver of the video signal captured by the telecamera and is adapted to be connected to the fishing line of a fishing rod near the hook of the fishing line to film the fish when it approaches the bait. The receiver unit is adapted to be arranged near the user and includes a receive driver of the video signal with suitable video outputs adapted to be connected to a display device to display the images filmed by the telecamera.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present patent application for invention relates to a video capture system in general for fishing and for low-cost documentary films.

The invention relates to the field of sports fishing, and in particular to the fishing technique known as “trolling”. Trolling is practiced all over the world as entertainment activity using easy-to-find equipment. This sport can be practiced all over the world without any type of limitations; moreover, a booming tourism activity is related with the organization of fishing travels and holidays in very famous resorts.

2. Description of Related Art Including Information Disclosed Under 37 CFR 1.97 and 37 CFR 1.98.

One of the most important aspects related with the capture of predators is the documentation, which is mostly photographic, of the quality of the catch. Once the fish has been hoisted out of the water into the boat, regardless of the fact that it is released or not, the fish is filmed as a proof of skill. In actual fact, the most important documentation should refer to the capture in water, from the moment in which the predator sees the bait to the moment in which the fish is hoisted onto the boat, passing through the “fight” and resistance of the fish.

Trolling is practiced with a fishing line that comes out of the fishing rod in the boat for a length that varies from thirty to sixty meters approximately and this causes severe technical constraints for the realization of a device able to capture the images of the fish when it is caught.

In fact, the catch must be filmed with a device composed of a telecamera, a transmission means, an electrical power supply means and a receiver. The video capture device must be immersed in water, must be compact in size, must not interfere with the fishing activities, must provide acceptable operation autonomy and must be easy to handle.

There are the three main problems to solve:
To realize a transmission means with very small size in order not to interfere with the fishing activity and to distribute the acquired video signal through a connection provided with the same characteristics of lightness and miniaturization.
To provide and suitably distribute the electrical power that is necessary to operate the video capture device, which is immersed in water.
To integrate the various components in such a way not to hinder or impair the efficacy of the fishing technique that is used on the boat.

The known technique has not been able to solve the said problems and for this reason, there are no video capture systems integrated in a fishing rod that are able to film the fish when it takes the bait during trolling.

The purpose of the present invention is to solve the aforementioned problems by providing a video capture system for fishing, which is reliable, efficient, autonomous and integrated in a fishing rod without interfering with the fishing activity.

U.S. Pat. No. 6,057,879 discloses a fishing surveillance device, wherein the video signal transmission line is separated from the fishing line.

U.S. Pat. No. 5,511,335 discloses a fishing lure comprising a sensor assembly transmitting signals to above water circuit. The transmission line is integrated into the fishing line.

W02007/043041 discloses a flotation device for underwater observation.

W02007/111441 discloses a circuit to transmit video signal using an AC power line.

U.S. Pat. No. 6,525,762 discloses a wireless underwater videoed system.

This purpose has been achieved according to the invention with the characteristics described in the enclosed independent claim 1.

Advantageous embodiments of the invention are disclosed in the dependent claims.

### SUMMARY OF THE INVENTION

According to the invention, the video capture system, in particular for fishing, comprises:
a transmitter unit comprising a telecamera and a transmit circuit of the video signal captured by the telecamera, said transmitter unit being adapted to be connected to the fishing line of a fishing rod near the hook to film the fish when it approaches the bait,
a receiver unit adapted to be positioned near the user and comprising a receive circuit of the video signal with at least one video output adapted to be connected to a display device to display the images filmed by the telecamera, and
A cable transmission line that connects the transmitter unit to the receiver unit.

The advantages of the video capture system according to the invention are evident.

The possibility of video capture with the device of the invention is extremely interesting for fishing purposes and also from the theoretical viewpoint, since it is achieved without modifying the parameters of the natural environment of the prey, which can be studied in its natural hunting behavior. From a technical viewpoint, the device of the invention provides a visual proof of the dynamic behavior of the bait, of the attack or refusal of the fish and of other environmental parameters that cannot be observed otherwise. From the sports viewpoint, the device advantageously provides a precise documentation of the fishing activity, which can be shared and stored. The device of the invention can be simply integrated in the fishing equipment, can be used to identify anomalous situations during fishing (artificial bait covered with algae) and can provide information on the actual capability of the fishing technique.

### BRIEF DESCRIPTION OF THE DRAWINGS

Additional characteristics of the invention will appear evident from the following detailed description, which refers to merely illustrative, not limiting embodiments, illustrated in the enclosed drawings.

FIG. 1 is a diagrammatic schematic view of a video capture system according to the invention used for trolling.

FIG. 2 is a block diagram that illustrates a first embodiment of the video capture system of FIG. 1.

FIG. 3 is a circuitry diagram of the block diagram of FIG. 2.

FIG. 4 is a block diagram that illustrates a second embodiment of the video capture system of the invention.

FIG. 5 is a circuitry diagram of the block diagram of FIG. 4.

FIG. 6 is a block diagram that illustrates in detail the transmitter unit of the video capture system of FIG. 4.

FIG. 7 is a block diagram that illustrates in detail the receiver unit of the video capture system of FIG. 4.

FIG. 8 is a diagrammatic view that illustrates a fishing line in which a transmitter unit of the video capture system of the invention is mounted.

FIG. 9 is the same as FIG. 8, except for it illustrates an improvement of the fishing line.

FIG. 10 is a cross-sectional view along the plane X-X of FIG. 9.

### DETAILED DESCRIPTION OF THE DRAWINGS

The video capture system, in particular for fishing, of the invention is disclosed with reference to the enclosed figures.

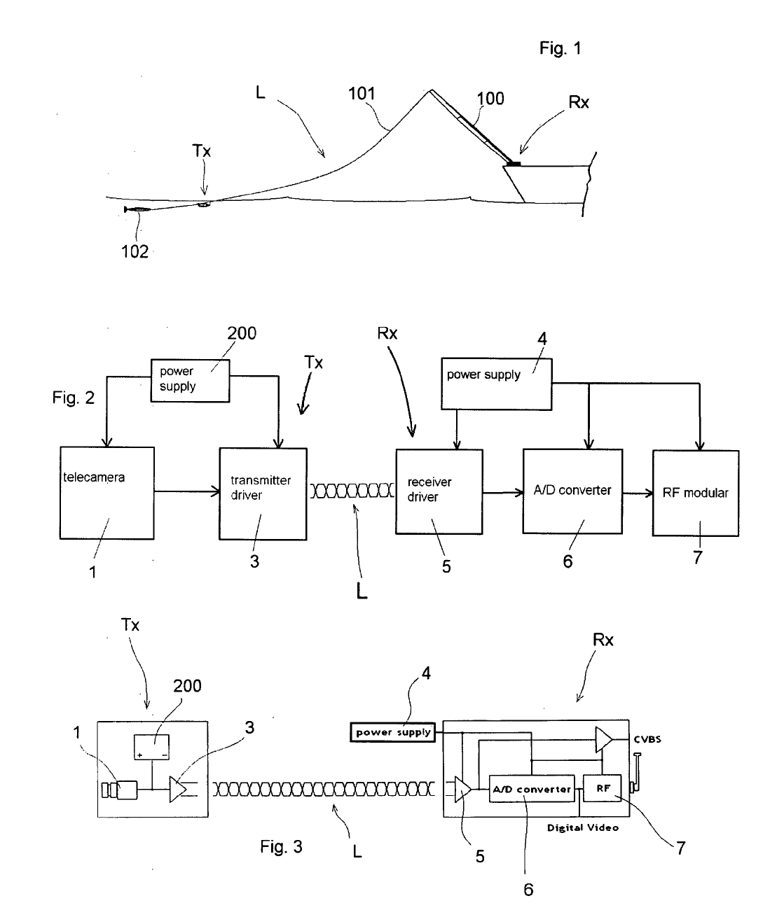

With reference to FIG. 1, a fishing rod, in particular for trolling, is disclosed. The fishing rod comprises a rod (100) that is anchored, for instance, on a boat. The rod (100) supports a fishing line (101) provided at the end with a hook (102), eventually with bait. The fishing line (101) is wound with a reel normally provided on the rod (100).

The video capture system of the invention comprises a transmitter unit (Tx) adapted to be positioned near the hook (102) of the fishing line and a receiver unit (Rx) adapted to be positioned near the user. The transmitter unit (Tx) is connected to the receiver unit (Rx) over a cable transmission line (L), as illustrated below.

With reference to FIGS. 2 and 3, the transmitter unit (Tx) comprises a video acquisition device (1), a power supply device (200) and a transmit circuit (driver) (3). The video acquisition device is an underwater microtelecamera (1), such as, for example, a Sharp telecamera, with composite video output, with 32 mm×32 mm×32 mm(H) dimensions.

The driver circuit (3) is provided with an equalizer to equalize the analogue video signal filmed by the telecamera (1) and a transmitter to transmit the equalized signal over the transmission line (L). The driver circuit (3) can be integrated in a printed circuit board.

The power supply device (200) must provide a battery and an adapter circuit to power the telecamera (1) and the driver circuit (3).

The receiver unit (Rx) comprises a receive circuit (driver) (5) and optionally a video digitalization circuit (6) and a radiofrequency over-the-air transmit circuit (7). The receive driver (5) comprises a receiver and an equalizer to receive and equalize the analogue video signal transmitted over the transmission line (L) to obtain an outgoing composite video analogue signal (CVBS). A display device can be connected to the composite video output (CVBS) to display the images filmed by the camera (1) in real time.

The digitalization circuit (6) comprises an analogue-digital converter and a digital video output that can be connected to a display device for a better display of the images filmed by the camera. The radiofrequency transmit circuit (7) comprises a radiofrequency modulator and a radiofrequency transmit antenna for wireless connection with a display device. The transmit circuit (5), ND converter (6) and RF modulator (7) can be integrated in a printed circuit board.

The receiver (Rx) is provided with power supply (4) to power the receive circuit (5), the analogue/digital converter (6) and the radiofrequency modulator (7).

Nevertheless, such a video capture system is impaired by the difficulties encountered to insert a suitable battery pack (200) in the transmitter (Tx). In fact, the battery (200) causes the following problems to the transmission circuit in water:
The battery (200) must be removed for recharging: This makes it especially difficult to find a waterproof micro-connector suitable to connect the battery (200) to the camera (1) and to the transmit driver (3). Although it is possible to design a wireless recharging system of the camera and transmit circuit (3), this makes it difficult to maintain the small size of the transmitter of the transmit driver (3).
The battery (200) must have a small size, but good capacity. The dimensioning of power for the transmitter of the transmit driver (3) requires a battery (200) of at least 1.5-2 W. Currently, 150 mAh 3V lithium-polymer battery packs have 4×20×20 mm size (for example, a MAXPOWER battery). In the specific case, at least three battery packs must be combined to meet the power requirements of the transmitter, with a volume of 12×20×30 mm and a weight of many grams. Therefore, a switching power supply must be designed to provide the correct power to the transmit driver (3) and the camera (1).

A simple solution to this problem could be to get the power directly from the power supply (4) of the receiver, using a dedicated power supply line that connects the power supply (4) to the transmitter (Tx). However, such a solution is impaired by some drawbacks, due to the presence of the dedicated power supply line, which is rather cumbersome and is a hindrance for the fishing line (101) of the fishing rod.

The problem has been solved by designing a transmitter (Tx) powered by the same video cable (L). In practical terms, electrical power supply has been inserted in the same physical support (L) of the video transmission. In view of the above, power supply (4) only resides on the receiver (Rx) that sends it to the balanced video cable (L). The transmitter (Tx) splits power supply for its own requirements and provides the video signal on the same cable (L) used for power supply.

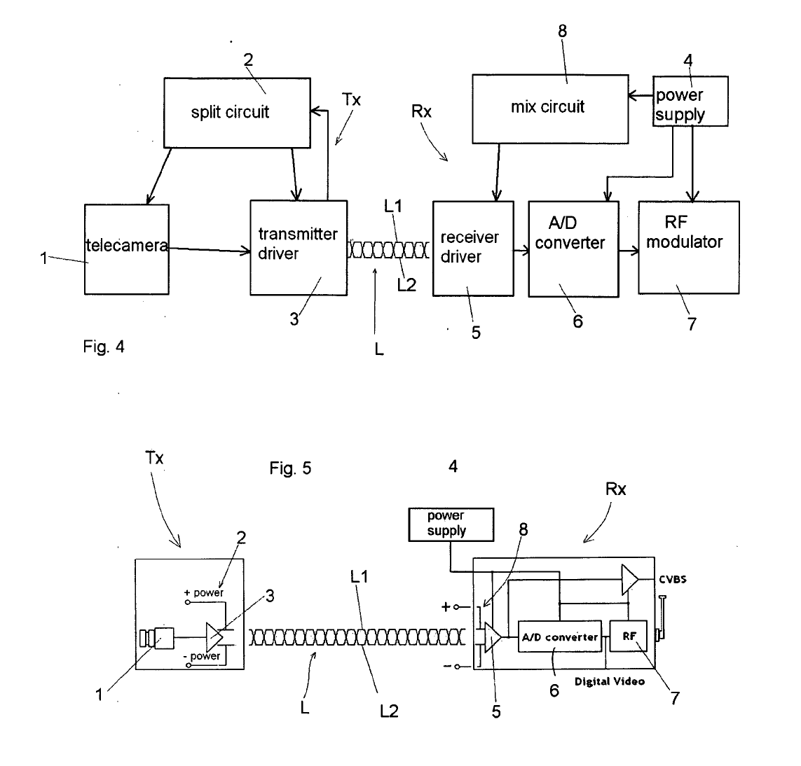

As shown in FIGS. 4 and 5, it has been necessary to design:
a mixing circuit (8) in the receiver (Rx) represented by a non-linear time-invariant transfer function and implemented by a semiconductor and passive components to mix in frequency linear high impedance mode the power supply from the power supply (4) on the base band video signal sent to the transmitter (Tx) over the line (L), and
a splitting circuit (2) in the transmitter (Tx) is represented by a non-linear time-invariant transfer function and implemented by a semiconductor and passive components to split in frequency linear high impedance mode the power supply signal from the base band video signal transmitted over the transmission line (L).

The split and mixing circuits, as briefly described above, have the following advantages:
they prevent the use of any kind of video signal modulation and demodulation and the use of bulky and fragile electromagnetic passive component like inductance or transformer. This new technology allows to develop a small integrated circuit strongly necessary in this particular application where reliability, miniaturization and integration are the basic requirements for the purpose of invention.
the DC current of power supply it is simply derived from the boat power supply (AC power supply it's typical only for Power Line) and DC power supply avoid any modulation and demodulation circuit necessary to send video signal into AC power supply. Also in AC power supply line it is necessary to use a transformer ad a rectifier to create a DC voltage in the TX circuit and send the modulated video signal.

Advantageously, the transmission line (L) is provided with a UTP cable that comprises only a pair of unscreened twisted cables (L1, L2). The cables (L1, L2) are preferably multi-wire cables composed of a plurality of copper strands. The UTP cable reduces the interference of the video signal that is being transmitted. It must be noted that such a UTP cable has an approx. diameter of 1 mm and therefore is not a hindrance for fishing.

A technique has been used to minimise the interference on the video signal by reducing the phase problems introduced by the same circuit.

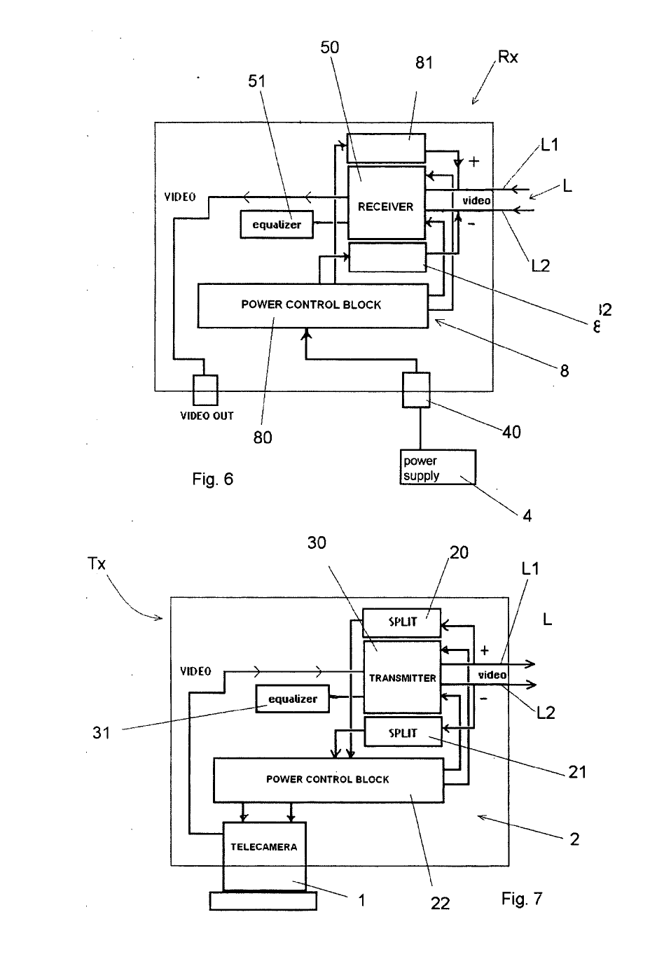

As shown in FIG. 6, an external power supply (4), which can be a battery or a power supply provided in the boat, is connected to a connector (40) of the receiver (Rx). The connector (40) is connected to a power control block (80) that powers the receiver circuit (50) and the equalizer (51). The power control block (80) is connected to two mixers (81, 82) that send power supply (+) and (−) on the two cables (L1, L2) of the UTP cable, mixing it with the video signal transmitted by the cables (L1, L2).

As shown in FIG. 7, the split circuit (2) provided in the transmitter unit (Tx) is provided with two splitters (20, 21) respectively connected to the cables (L1) and (L2) to split the power signals (+) and (−) coming from the receiver unit (Rx) from the video signals introduced on the cables (L1, L2) by the transmit circuit (30) of the transmitter unit (Tx).

The splitters (22) are connected to a power control block (22) that receives power from the splitters (20, 21) and distributes it to the transmitter (30), equalizer (31) and camera (1).

The dimensioning of the power supply (4) provided by the receiver (Rx) to the transmitter (Tx) has considered the relevant resistive losses. Said resistive losses are not negligible since the transmission cable (L) has a very small section and therefore a bonding resistance of 25 Ohm every 100 meters. Additionally, the losses of the split circuit (2) must be considered. Said losses have been balanced by calculations in order to provide supply voltage at the ends of the transmitter (30) with the ideal nominal value for the components to minimize the operation of the internal electrical adjusters.

The calculations have resulted in the following power:
Power requested for copper losses in cables (L1, L2) +video transmitter power (30)+camera power supply (1)=3 W
Receiver power (50)=1.1 W.

As shown in FIG. 8, the transmitter unit (Tx) is contained inside a waterproof casing (10) with oblong shape that is provided at the end with the camera (1) facing the ending section (103) of the fishing line with the hook. The body (10) of the transmitter is slidingly mounted on the fishing line (101), for example by means of ring-shaped slides (11). The transmitter unit (Tx) slides and is guided by the fishing line (101) due to gravity and also because of the motion of the boat and the friction of the water that take it towards the bait. A stopper (12) in the fishing line stops the descending travel of the transmitter unit (Tx) that remains tense and directed towards the bait. The front slide (11) of the transmitter unit (Tx) is stopped against the stopper (12).

Generally, the ending section (103) of the fishing line with the bait is connected to the fishing line (101) by means of a round element (104). Therefore, the stopper (12) is positioned in the fishing line (101) at a short distance from the round element (104).

The UTP cable (L) is connected in the back of the body (10) of the transmitter and is arranged in parallel position to the fishing line (101). The electrical connection of the UTP cable (L) is not stressed by the catch of the fish and does not hinder fishing, since the UTP cable (L) is recovered on the boat by means of a reeling system with automatic or manual fly reel.

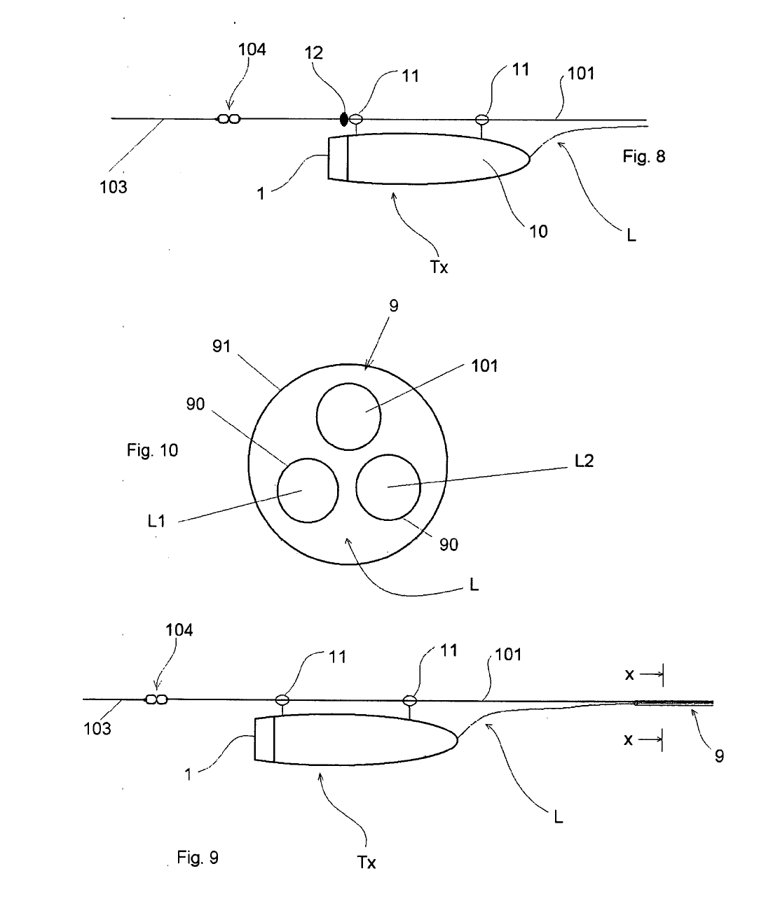

FIGS. 9 and 10 illustrate a further evolution of the video 5 capture system of the invention, in which, instead of being coated with insulation sheath, the two electrical cables (L1, L2) of the UTP cable (L) are coated with enamel insulation (90) (similar to wires in electrical transformers). In this way a considerable reduction of the total section of the UTP cable is obtained.

In this case a braided fishing thread (101) is used to ensure suitable mechanical resistance with reduced section. The UTP cable (L) and the braided thread (101) are coated with a microsheath (91) of the type used in some types of fishing threads. In this way, a fishing line (9) that comprises the braided cable (101) and the UTP cable is obtained (L). The fishing line (9) is attached to a fly reel arranged on the fishing rod, which provides for some modifications, such as a coil to manage the electrical signal.

Considering the electrical multi-wire cables (L1, L2) in 26AWG-24AWG size, the fishing line (9) may have a total diameter of 1.8-2 mm. The choice of multi-wire cables (L1, L2) gives higher flexibility and better softness compared to single-wire cables.

At the end of the fishing line (9), the electrical cables (L1, L2) are separated from the braided cable (101), which continues and is attached to a snap-hook to insert the bait. The transmitter unit (Tx) is provided with a mechanical fixing means (11) to the braided cable (101) to stabilize the camera (1).

The advantages of the device of the invention are numerous:
smaller size, lower weight and lower mechanical complication of the transmitter (Tx),
the technology that provides for inserting the remote power supply on the UTP cable (L) that transports the video signal allows for ideal power control, since the receiver (Rx), which is generally mounted on the boat, can use a battery pack (4) of suitable dimensions,
the use of a UTP cable (L) with only two wires (L1, L2) allows for better integration in the fishing system due to the small dimensions.

A further development of the device may be employed for spinning fishing in fresh water, where video capture is in digital format and the information is stored in an internal memory contained in the device with the camera (1). In this way, after hoisting, the transmitter unit (Tx) makes the film available through a radio digital connection. The device can also be used alone, without bait, for visual reconnaissance of fishing area.

In such a case, a digitalization and video compression circuit is integrated in the circuit that contains the camera (1) and a solid memory is used to collect the information. After recovering the device, a radio digital connection is used to transfer the video file to any multimedia player and see the fish population in the explored area.

Numerous variations and modifications can be made to the present embodiments of the invention by an expert of the field, while still falling within the scope of the invention as claimed in the enclosed claims.

1. Video capture system, in particular for fishing, comprising:
A transmitter unit (Tx) comprising a telecamera (1) and a transmit driver (3) of the video signal captured by the camera (1), said transmitter unit (Tx) being adapted to be connected to the fishing line (101) of a fishing rod in such a way to be positioned near the hook (102) of the fishing line to film the fish when it approaches the bait,
A receiver unit (Rx) adapted to be positioned near the user and comprising a receive driver (5) of the video signal with at least one video output adapted to be connected to a display device to display the images filmed by the camera (1), and
A cable transmission line (L) that connects the said transmitter unit (Tx) to the said receiver unit (Rx).

2. Video capture system according to claim 1, characterised in that it comprises a power source (4) connected to the receiver unit (Rx) to power the receive driver (5) and send the power supply over the cable transmission line (L) to power the camera (1) and the transmit driver (3).

3. Video capture system according to claim 2, characterised in that the power supply from the power source (4) is sent over the same cables of the transmission line (L) that transmit the video signal.

4. Video capture system according to any one of the above claims, characterised in that the cable transmission line (L) comprises a UTP cable with only one pair of unscreened twisted multi-wire cables (L1, L2).

5. Video capture system according to claim 3 or 4, characterised in that:
The receiver unit (Rx) comprises a mixer circuit (8) to mix the power supply from the power source (4) with the video signal transmitted over the cable transmission line (L), and
The transmitter unit (Tx) comprises a split circuit to split the power supply from the video signal transmitted over said cable transmission line (L) in such a way to power the transmit driver (3) and the camera (1).

6. Video capture system according to any one of the above claims, characterised in that the transmitter unit (Tx) is contained in a watertight enclosure (10) that is slidingly mounted on the fishing line (101) of the fishing rod.

7. Video capture system according to any one of the above claims, characterised in that the cable transmission line (L) comprises a pair of multi-wire cables (L1, L2) coated with insulation enamel (90).

8. Video capture system according to claim 7, characterised in that the fishing line (101) comprises a braided thread that is contained together with the multi-wire cables (L1, L2) inside a microsheath (91).

9. Video capture system according to any one of the above claims, characterised in that the receiver unit (Rx) also comprises an A/D converter (6) with a digital video signal output.

10. Video capture system according to any one of the above claims, characterised in that the receiver unit (Rx) also comprises a modulator (RF) with a transmit antenna to transmit the radiofrequency modulated video signal over the air.

11. Video capture system according to any one of the above claims, characterised in that the transmitter unit (Tx) and/or the receiver unit (Rx) comprise a memory to store the video signal captured by the camera (1).

12. Fishing rod characterised in that it comprises a video capture system according to any one of the above claims.
